(19) United States
(12) Patent Application Publication
(10) Pub. No.: US 2011/0041807 A1
(43) Pub. Date: Feb. 24, 2011

(54) DAMPING ARRANGEMENT FOR A FUEL INJECTOR

(75) Inventor: MICHAEL P. COOKE, GILLINGHAM (GB)

Correspondence Address: Delphi Technologies, Inc., M/C 480-410-202, P.O. Box 5052, Troy, MI, 48007, US

(73) Assignee: DELPHI TECHNOLOGIES HOLDING, S.ARL, BASCHARGE (LU)

(21) Appl. No.: 12/913,994

(22) Filed: Oct. 28, 2010

Related U.S. Application Data
(63) Continuation of application No. 11/725,464, filed on Mar. 19, 2007.

(30) Foreign Application Priority Data
Mar. 20, 2006 (EP) 06251470.8

(51) Int. Cl. F02M 69/04; F02M 47/02

(52) U.S. Cl. 123/445; 239/91

(57) ABSTRACT

A fuel injector for use in an internal combustion engine, the fuel injector comprising: a valve needle which is engageable with a valve needle seat to control fuel injection through an injector outlet; an actuator arrangement arranged to control fuel pressure within a control chamber, a surface associated with the valve needle being exposed to fuel pressure within the control chamber such that fuel pressure variations within the control chamber control movement of the valve needle relative to the valve needle seat; damping means for damping opening movement of the valve member, the damping means comprising a damper chamber and the damping means being arranged such that fuel pressure variations within the damper chamber damp opening movement of the valve member wherein the damping means is arranged such that in use there is a through flow of fuel through the damper chamber.

### CROSS-REFERENCE TO RELATED APPLICATION

This application is a continuation application of U.S. Ser. No. 11/725,464, filed Mar. 19, 2007, and entitled “DAMPING ARRANGEMENT FOR A FUEL INJECTOR”.

### TECHNICAL FIELD OF INVENTION

The present invention relates to a fuel injector for delivering fuel to a combustion space of a compression ignition internal combustion engine. In particular, but not exclusively, the invention relates to a fuel injector including a piezoelectric actuator for controlling movement of an injector valve needle.

### BACKGROUND OF INVENTION

Piezoelectric actuators comprise a stack of piezoelectric elements which are arranged to control fuel pressure within a control chamber within the fuel injector arrangement. Fuel pressure variations within this control chamber result in the opening or closure of the valve needle.

Known fuel injectors of the type comprising a piezoelectric actuator are either arranged such that a reduction of voltage across the piezoelectric stack initiates an injection event (a so-called “de-energise-to-inject” injector) or are arranged such that an increase of voltage across the piezoelectric stack initiates an injection event (a so called “energise-to-inject” injector).

Known “energise-to-inject” piezo-electric injectors often incorporate a damping chamber to control the oscillation of the needle as it is lifted from its seating. Such a damping arrangement helps improve the control of the valve needle. Such injectors often have damping arrangements in which the fuel that is used for damping shuttles back and forth either to a dead ended damping chamber or to a relatively long passage through the valve needle. This limits the exchange of damping fuel with fresh fuel and means that only relatively light damping can be applied without giving rise to excessive fuel temperatures in the damping chamber.

The applicant's co-pending application EP 05250254 describes an “energise-to-inject” injector which comprises a damping arrangement which damps the opening of the valve needle. The damping chamber comprises a restricted passageway that allows fuel to enter the damping chamber from the accumulator volume. The restricted passageway damps both the valve needle lift and also the valve needle closure. As such, the restricted passageway cannot be made too restrictive otherwise the needle closure will be too slow.

It is with a view to addressing at least one of the aforementioned problems that the present invention provides an improved fuel injector, as set out below.

### SUMMARY OF THE INVENTION

According to an embodiment of the present invention, there is provided a fuel injector for use in an internal combustion engine. The fuel injector includes an inlet for receiving fuel, an accumulator volume, a valve needle, a valve needle seat, a control chamber, an injector outlet, an actuator arrangement, and damping means for damping opening movement of the valve needle. The accumulator volume is located within the fuel injector and is configured to define a fuel passageway for fuel to flow from the inlet to the injector outlet. The valve needle is engageable with the valve needle seat to control fuel injection through the injector outlet. The actuator arrangement is arranged to control fuel pressure within the control chamber. A surface associated with the valve needle is exposed to fuel pressure within the control chamber such that fuel pressure variations within the control chamber control movement of the valve needle relative to the valve needle seat. The damping means includes a damper chamber containing fuel, a damper valve, a first fluid path that includes a vent passage, and a second fluid path that includes a damping orifice. The damper valve also defines a portion of a first fluid path is characterized as having variable restriction between a first location in the accumulator volume to a first end of the damper chamber. The vent passage defines another portion of the first fluid path between a first location in the accumulator volume to the first end of the damper chamber. The damping orifice defines part of a second fluid path and is characterized as having fixed restriction directly from a second end of the damper chamber to a second location in the accumulator volume spaced apart from the first location. The accumulator volume is configured such that fuel flows past the first location and the second location as fuel flows through the injector outlet. By this arrangement, fuel at the first location and the second location is refreshed. Furthermore, the second fluid path is distinct and separate from the first fluid path. The damping orifice is characterized as having a restricted diameter effective for damping. The damper valve is arranged such that fuel flowing out of the damper chamber flows only through the damping orifice during opening movement and so is restricted so as to damp opening movement of the valve needle. The vent passage is arranged to provide an additional fuel flow path through the damper valve into the damper chamber during closing movement of the valve needle. The first fluid path and the second fluid path connect to the damper chamber at locations that are substantially displaced, thereby providing for a flow of fresh fuel through the damper chamber from the first end of the damper chamber to the second end of the damper chamber.

The present invention provides for a fuel injector comprising an injector needle, the position of which is controlled by fuel pressure variations in a control chamber. The fuel pressure in the control chamber is, in turn, controlled by an actuator arrangement.

A damping means is also provided for damping the opening motion of the valve needle. The damping means comprises a damper chamber which is also exposed to fuel pressure variations. These fuel pressure variations provide damping for the opening motion of the valve needle.

It is noted that the damper chamber and control chamber are separate chambers. This allows the damper chamber to be arranged such that there is a through flow of fuel through the damper chamber. This ensures that the fuel within the damper chamber does not undergo excessive heating during operation of the fuel injector and therefore ensures that the problems associated with the prior art, namely changes in bulk modulus and viscosity, are substantially overcome.

The damping means is additionally arranged such that the closing of the valve needle is damped less than the damping during valve needle opening. This allows the valve needle to be quickly closed. Conveniently, closing of the valve needle is substantially less damped than the damping during needle opening and preferably the closing of the valve needle is substantially undamped.

Conveniently, the injector is arranged such that an increase in fuel pressure within the control chamber causes the valve needle to lift away from the valve needle seat.

The actuator may preferably take the form of a piezoelectric actuator that comprises a stack of piezoelectric elements arranged within an accumulator volume for receiving fuel from the source of pressurised fuel. Such an actuator is arranged such that increases in the stack length result in an increase in pressure within the control chamber. This arrangement is referred to as an “energise to inject” type of fuel injector.

Preferably the valve needle is biased towards its seating such that the injector closes in the event of an injector failure. In order that the needle is biased in this way the damper chamber preferably comprises a spring which serves to urge the valve needle towards its seating.

Conveniently, the fuel injector comprises a sleeve member which partially or fully encloses components of the injector. The sleeve member is in communication with the actuator arrangement such that movement of the actuator is transmitted to the sleeve member. The sleeve member will co-operate with the actuator arrangement such that a force applied to the sleeve by the actuator arrangement will cause pressure within the control chamber to vary.

The sleeve member comprises a bore which, together with a surface associated with the valve needle, partially defines the control chamber.

Conveniently, the damper chamber is in fluid communication with a source of pressurised fuel by means of a restricted, damping orifice in the sleeve member. This restricted (or damping) orifice restricts the flow of fuel into the damper chamber and therefore provides a mechanism for damping the lifting of the valve needle.

Conveniently, the actuator is housed within an accumulator volume, the accumulator volume being in communication with the source of pressurised fuel. Therefore, preferably, the damping orifice from the damper chamber is in fluid communication with the accumulator volume.

Conveniently, the sleeve member defines in part the damper chamber. It is noted however that the damper chamber and control chamber are not in direct fluid communication with one another.

Preferably, the damper chamber further comprises a vent passage (or passages) providing a flow path from the source of pressurised fuel to the damper chamber. The damping means preferably, in this instance, further comprises a valve member which serves to block this flow path when in a seated position. When the valve member is in an unseated position however the flow path is unblocked. The vent passage(s) and valve member provide a means for providing damping during opening of the valve needle and undamped closure of the valve needle.

As the needle is lifting the damper chamber reduces in volume. The damping orifice, which is a restricted orifice, is the only outlet for fuel within the damper chamber during needle lift. Needle opening is therefore damped.

During needle closure the damping orifice restricts the rate at which fuel can enter the damper chamber from the pressurised fuel source. This results in a drop in pressure within the damper chamber which, in turn, causes the valve member to lift from its seating. As the valve member moves to its unseated position the vent passages are uncovered. Fuel from the pressurised source is therefore able to enter the damper chamber via the vent passages (in addition to the damping orifice) and consequently, needle closure is substantially undamped.

It is noted that the spring provided within the damper chamber preferably acts upon the valve member to bias it into contact with the valve needle and into its seated position. In this manner the valve needle is also biased towards its seating. During needle closure the pressure drop within the damper chamber is sufficient to overcome the action of the spring.

Conveniently, the valve member may be provided as an annular valve member that is in close communication with the bore of the sleeve member. In its seated position such an annular valve member forms a substantially fluid tight seal between the inside of the sleeve bore and the valve needle. In its unseated position, fluid is able to flow through the vent passage in the sleeve member and through the centre of the annular valve member into the damper chamber.

The unseating of the valve member during valve needle closure allows the fluid within the damper chamber to be recycled and also provides for substantially undamped valve needle closure.

In order to allow the control chamber to track fast changes in the rail pressure of the system the control chamber may be connected to the source of fuel (accumulator volume) by a small orifice. Such an orifice also provides a mechanism for fast auto-closure of the valve needle in the event of faults in the actuator arrangement or associated drive circuit.

According to an embodiment of the present invention, there is provided a fuel injector for use in an internal combustion engine. The fuel injector includes an inlet coupled to a fuel source, a valve needle movable in an opening direction and a closing direction relative to a valve needle seat to control fuel dispensed through an injector outlet, an accumulator volume located within the fuel injector, and a damping means. The accumulator volume is configured to define a fuel passageway for fuel to flow from the inlet to the injector outlet. The damping means includes a damper chamber, a first fluid path, and a second fluid path. The damper chamber contains fuel. The first fluid path is between a first location in the accumulator volume and a first end of the damper chamber. The first fluid path includes a vent passage characterized as having a first restriction. The damping means also includes a second fluid path between a second location in the accumulator volume and a second end of the damper chamber. The second location is spaced apart and distinct from the first location in the accumulator volume. The second end of the damper chamber is substantially opposite the first end of the damper chamber. The second fluid path includes a damping orifice characterized as having a second restriction greater than the first restriction and is effective for damping. The accumulator volume is configured such that fuel flows past the first location and the second location as fuel is dispensed through the injector outlet. By this arrangement, fuel at the first location and the second location is refreshed. The damping means also includes a damper valve arranged series wise in the first fluid path. The damper valve is characterized as having variable restriction. The damper valve is configured such that fuel flowing out of the damper chamber flows only through the second fluid path when the needle moves in the opening direction so as to damp opening movement of the valve needle. The damper valve is also configured so fuel flows through the damper valve when the needle moves in the closing direction such that fuel flows through the first fluid path and the second fluid path when the needle moves in the closing direction. With this arrangement, a flow of fresh fuel is provided through the damper chamber from the first end of the damper chamber to the second end of the damper chamber.

Although the above embodiments of the present invention have been described in relation to a single valve needle injector it is noted that the present invention may also be applied to the inner valve needle of a variable orifice needle (as described in the Applicant's co-pending application EP05250254.9). When the inner valve is lifted in such a variable orifice needle the functionality is as described above.

The present invention may be applied to an injection nozzle for use with a fuel injector as described above.

### BRIEF DESCRIPTION OF DRAWINGS

In order that the invention may be more readily understood, reference will now be made, by way of example, to the accompanying drawings in which:

FIG. 1 is a sectional view of an embodiment of the present invention;

FIG. 2 is an enlarged sectional view of a part of the fuel injector in FIG. 1;

FIG. 3 is a sectional view of the fuel injector of FIGS. 1 and 2 as the injector needle lifts from its seat;

FIG. 4 is a sectional view of the fuel injector of FIGS. 1 and 2 as the injector needle returns to its seat from the raised position shown in FIG. 3.

FIG. 5 is an enlarged view of part of FIG. 4.

FIG. 6 is a sectional view of a fuel injector according to an embodiment of the present invention in which the injector has an inner valve needle arranged concentrically within an outer valve needle

### DETAILED DESCRIPTION OF INVENTION

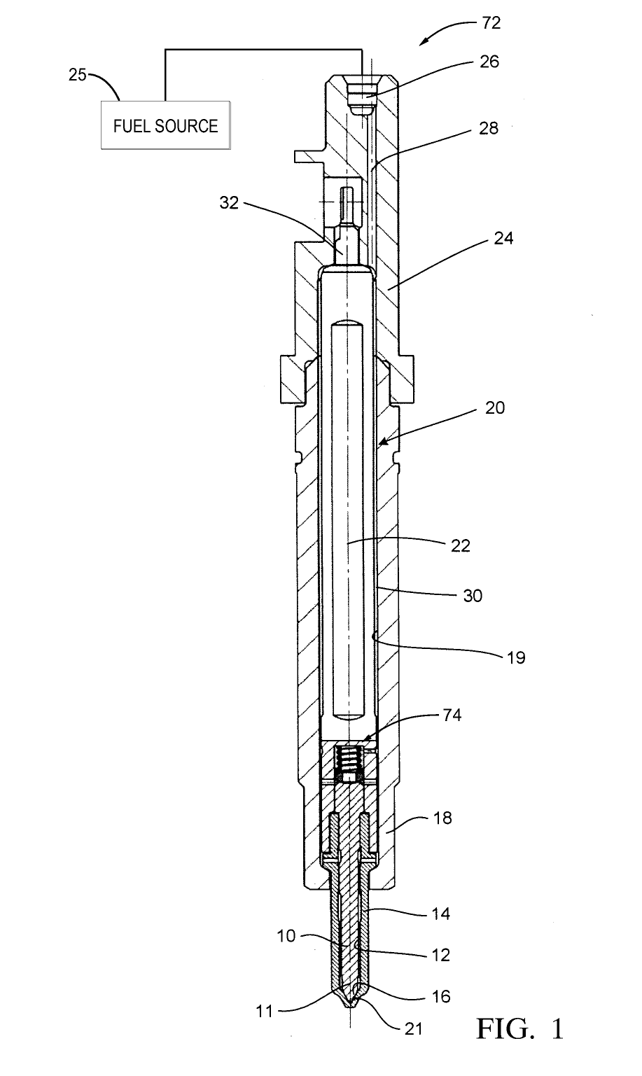

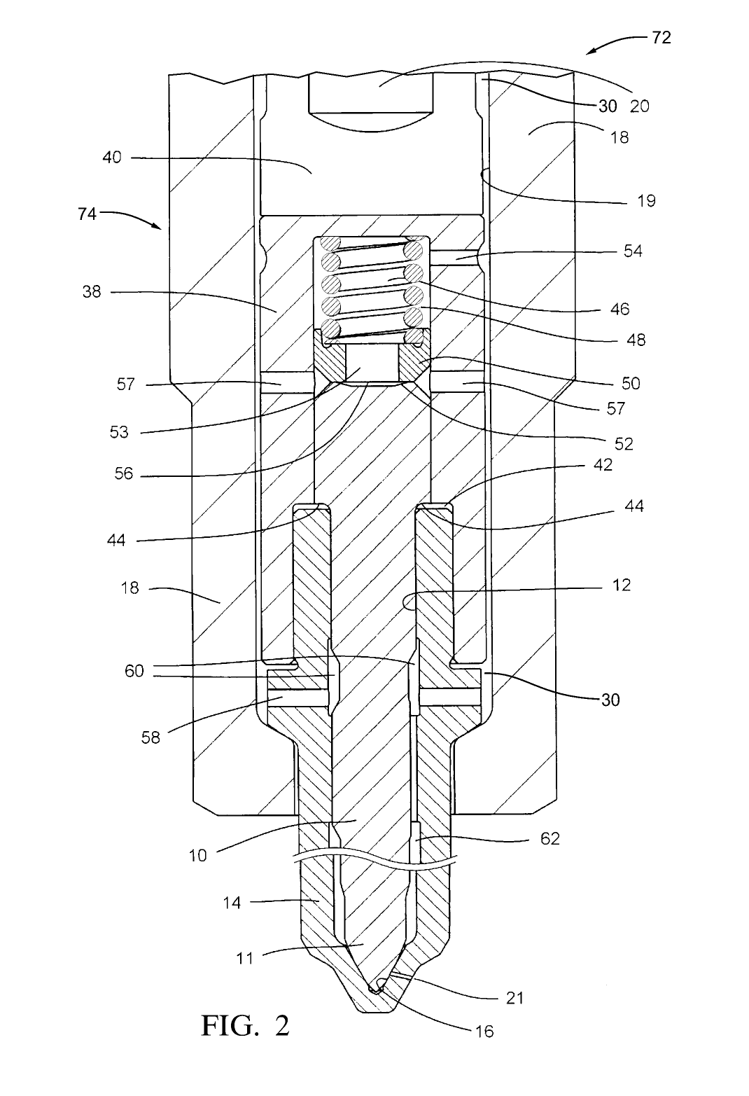

Referring to FIGS. 1 and 2, a fuel injector 72 of the energise-to-inject type includes a valve needle 10 which is slidable within a bore 12 provided in an injector nozzle body 14. The valve needle 10 includes a valve needle tip region 11 which is engageable with a valve needle seat 16 defined by the bore 12 to control fuel injection to an associated combustion space or engine cylinder. The injector nozzle body 14 is received, at its upper end, within an actuator housing 18 for a piezoelectric actuator 20 including a stack 22 of elements formed from a piezoelectric material. The piezoelectric actuator 20 is operable to control movement of the valve needle 10 between a non-injecting position, in which it is seated against the valve needle seat 16, and an injecting position in which the valve needle 10 is lifted away from the valve needle seat 16.

The valve needle 10 is shaped to include an upper guide region which forms a sliding fit within the nozzle body bore 12 so as to guide axial movement of the valve needle 10 as it moves relative to the valve needle seat 16.

The lower end of the nozzle body 14 projects from the actuator housing 18 so that injector outlets 21 (only one of which is shown) provided in said lower end extend into the engine cylinder. The upper end of the actuator housing 18 is received within an upper housing 24 including an inlet 26 for receiving high pressure fuel from a fuel source 25, typically in the form of a common rail. The inlet 26 communicates with a supply passage 28 provided in the upper housing 24. The actuator housing 18 is provided with a through drilling 19, an upper region of which defines an internal volume or “accumulator volume” 30. The supply passage 28 connects with the accumulator volume 30, which is filled with fuel at high pressure. The piezoelectric stack 22 is encapsulated within a sealant coating and received within the accumulator volume 30 so that the stack 22 is exposed continuously to a large hydraulic force due to fuel pressure within the volume 30.

The piezoelectric actuator 20 is also provided with an electrical connector 32 to which a voltage is applied across the stack 22 from an external voltage source (not shown). Being of the energise-to-inject type, the piezoelectric actuator 20 is configured such that, when under non-injecting conditions, a relatively low voltage is applied across the actuator stack 22. With only a relatively low voltage across the stack 22, the stack length is relatively short and the valve needle 10 occupies a position in which it is seated against the valve needle seat 16 so that fuel injection does not take place through the outlets 21. When a relatively high voltage is applied across the piezoelectric stack 22, the stack length is caused to increase and as a result the valve needle 10 lifts away from the valve needle seat 16 to commence injection. Operation of the fuel injector 72 will be described in further detail later.

Referring now to FIG. 2, extension and contraction of the stack 22 (in other words, stack movement) is transmitted to the valve needle 10 through a load transmission means arranged within a lower region of the actuator housing bore 19. The load transmission means takes the form of a motion inverter which converts downward movement (extension) of the piezoelectric stack 22 into upward (opening) movement of the valve needle 10, and vice versa. The motion inverter includes a sleeve 38 which is received within the lower region of the accumulator volume 30.

The piezoelectric stack 22 is surrounded by a sleeve which includes an end piece 40. An upper surface of the sleeve 38 abuts the underside of the end piece 40 so that, as the stack length is varied in use, movement of the stack 22 is transmitted to the sleeve 38.

A control chamber 42 for fuel is defined by a surface of the sleeve 38 and the upper end surface of the nozzle body 14. Fuel pressure within the control chamber 42 acts on a thrust surface 44 of the needle 10 in an upward direction. An outer surface of the nozzle body 14 defines a clearance with the radially inner side of the sleeve 38 through which fuel is able to flow into the control chamber 42.

A valve needle spring 46 is received within a damper chamber 48 defined within an upper end of the sleeve 38. The damper chamber 48 is filled with high pressure fuel which, together with the valve needle spring force, serves to urge the valve needle 10 into engagement with the valve needle seat 16. The pressure of fuel within the damper chamber 42 also serves to resist opening movement of the valve needle 10.

One end of the valve needle spring 46 abuts the underside of the upper surface of the sleeve 38 and the other end of the spring 46 abuts a damper valve arrangement 50, 52. The damper valve arrangement includes an annular damper valve 50 located within the damper chamber 48 and engageable with a valve seating 52 defined by an upper surface of the valve needle 10. The annular damper valve 50 defines a means for aiding rapid closure of the valve needle 10 at the end of injection, as discussed further below. The damper valve 50 is provided with a central drilling 53, one end of which communicates with the damper chamber 48 and the other end which communicates with a recessed portion 56 of the upper end of the needle 10.

The damper chamber 48 is provided with a radially extending drilling 54 to provide a fluid communication path between the damper chamber 48 and the stack chamber (accumulator volume) 30. The drilling (or damper orifice) 54 is of restricted diameter such that it provides a means for damping the opening of the valve needle 10 as described below.

The sleeve 38 is provided with further radially extending drillings 57 (vent passages). The damper valve 50 is subject to fuel pressure variations within the damper chamber 48 such that, in the event that the pressure within the chamber 48 varies sufficiently, the damper valve 50 may move from its seating 52 against the action of the spring 46 such that an additional flow path is opened between the damper chamber 48 and the accumulator volume 30 via the vent passages 57. The movement of the damper valve 50 and the flow path through the vent passages 57 is described in more detail below.

A fuel delivery means is provided between the accumulator volume 30 and the valve needle tip 11 to enable high pressure fuel to flow towards the region of the valve needle seat region at 16. The fuel delivery means includes an upper pair of radially extending drillings 58 in the nozzle body 14, an annular groove 60 provided at the upper end of the valve needle 10 and additional flutes (one of which is shown as feature 61 in FIG. 2 to the right of the needle 10) provided on the outer surface of the valve needle 10. The outer surface of the valve needle 10 and the nozzle body bore 12 are further shaped to define a fuel delivery chamber 62 between the groove 60 at the upper end of the valve needle and the valve needle tip 11 in the region of the valve needle seat 16.

From the foregoing description it will be appreciated that the inlet 26, the supply passage 28, the accumulator volume 30, the radial flow paths 58 in the nozzle body 14, the flutes 61 on the valve needle 10 and the fuel delivery chamber 62 together provide a flow path to permit high pressure fuel that is delivered to injector at the inlet 26 to flow to the valve needle tip 11 in the region of the seat 16.

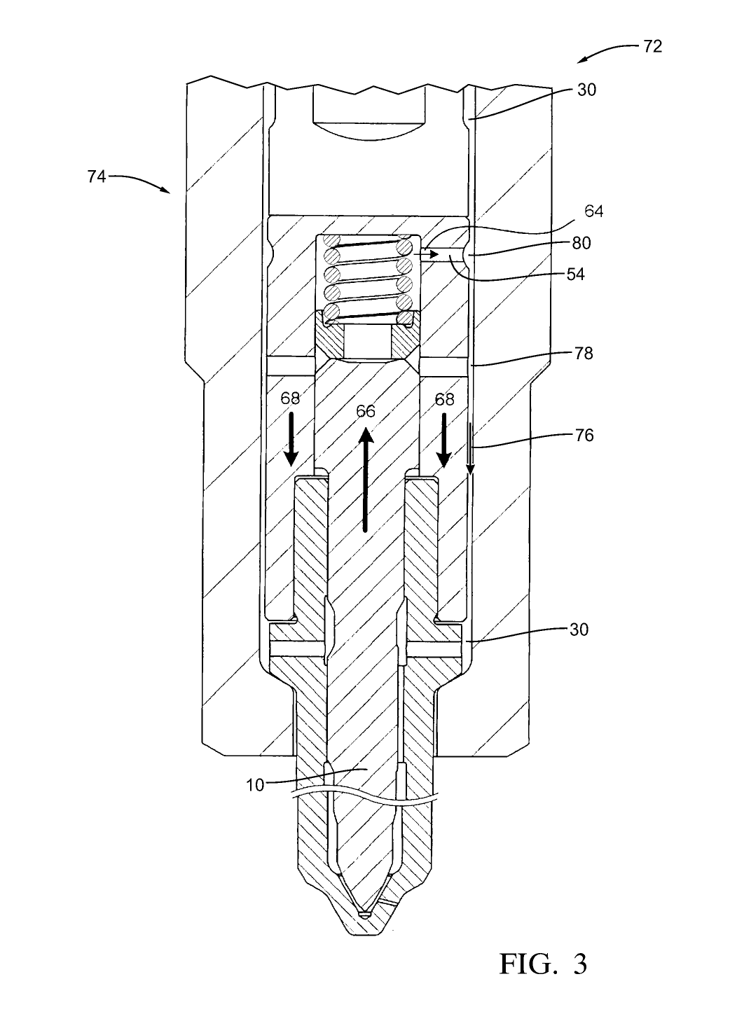

FIG. 3 shows the injector of FIG. 2 as the needle lifts from its seating and injection occurs.

Starting from the non-injecting condition shown in FIG. 2, the valve needle 10 is seated against the valve needle seat 16. Fuel is delivered through the delivery path 58, 60, and 62 but is unable to flow past the valve needle seat 16 to the injector outlets 21 as the valve needle 10 is seated. In this condition, the voltage across the piezoelectric stack 22 is at an initial voltage level that is relatively low and so the stack 22 has a relatively short length. Typically, the initial voltage level across the piezoelectric stack 22 is just greater than zero volts. With the stack 22 in its contracted state, the force acting on the sleeve 38 is low. Fuel pressure within the control chamber 42 is relatively low and, thus, the upward force acting on the thrust surface 44 due to fuel pressure in the control chamber 42 is relatively low.

Considering the forces acting on the valve needle 10, the net upward force acting on the valve needle 10 in the opening direction is determined by fuel pressure in the control chamber 42 which acts on the thrust surface 44 and by hydraulic forces acting on the valve needle 10 due to fuel pressure within the delivery path 60, 62. The net downward force acting on the valve needle 10 in the closing direction is determined by fuel pressure within the damper chamber 48 and the valve needle spring force. When the piezoelectric stack 22 is in its contracted state, fuel pressure within the control chamber 42 is sufficiently low that the net downward force on the valve needle 10 exceeds the net upward force and, thus, the valve needle 10 remains seated against the valve needle seat 16.

In order to initiate injection, the voltage applied across the piezoelectric stack 22 is increased to a relatively high level (the “injecting voltage level”). As a result, the length of the piezoelectric stack 22 is increased, causing the end of the stack 22 to transmit movement to the sleeve 38. The sleeve 38 is thus caused to move downwardly within the accumulator volume 30, causing the internal volume of the control chamber 42 to be reduced. As a result, fuel pressure within the control chamber 42 is increased.

As fuel pressure within the control chamber 42 increases, a point is reached at which the upwardly directed force acting on the coupled needle 10 is sufficient to overcome the force due to fuel pressure within the damper chamber 48 acting in combination with the valve needle spring force. When this condition occurs, the valve needle 10 starts to lift from the valve needle seat 16 as shown in FIG. 3.

The upward force on the valve needle 10 due to fuel pressure within the delivery path 60, 62 also acts to lift the needle 10. As the valve needle 10 starts to lift from the valve needle seat 16, fuel within the delivery chamber 62 is able to flow through the outlets 21 into the engine cylinder, and injection takes place into the engine cylinder.

As the valve needle 10 starts to lift to commence injection, the volume of the damper chamber 48 will reduce and fuel will flow through the damping orifice 54 into the accumulator volume 30. As the damper orifice 54 is of restricted diameter the flow of fuel through the orifice will be restricted and the lifting of the needle 10 will therefore be damped. Damping of opening movement of the valve needle 10 has been found to be advantageous as it avoids unwanted oscillation and overshoot of the valve needle at the desired lift.

The flow of fuel from the damper chamber 54 during needle lifting is indicated by the arrow 64. The motion of the needle 10 is indicated by the arrow 66 and the motion of the sleeve 38 is indicated by the arrow 68.

In order to terminate injection, the voltage across the piezoelectric stack 22 is reduced from the injecting voltage level to the initial voltage level, thereby reducing the length of the stack 22. As a consequence, the sleeve 38 is retracted upwards. As a result, fuel pressure within the control chamber 42 is reduced and a point is reached at which fuel pressure within the control chamber 42 is reduced to a sufficiently low level that the force of the valve needle spring 46, acting in combination with fuel pressure within the damper chamber 48, is sufficient to overcome the opening forces acting on the valve needle 10 to return the valve needle 10 against its seat 16. Injection of fuel through the outlet openings 21 is therefore terminated.

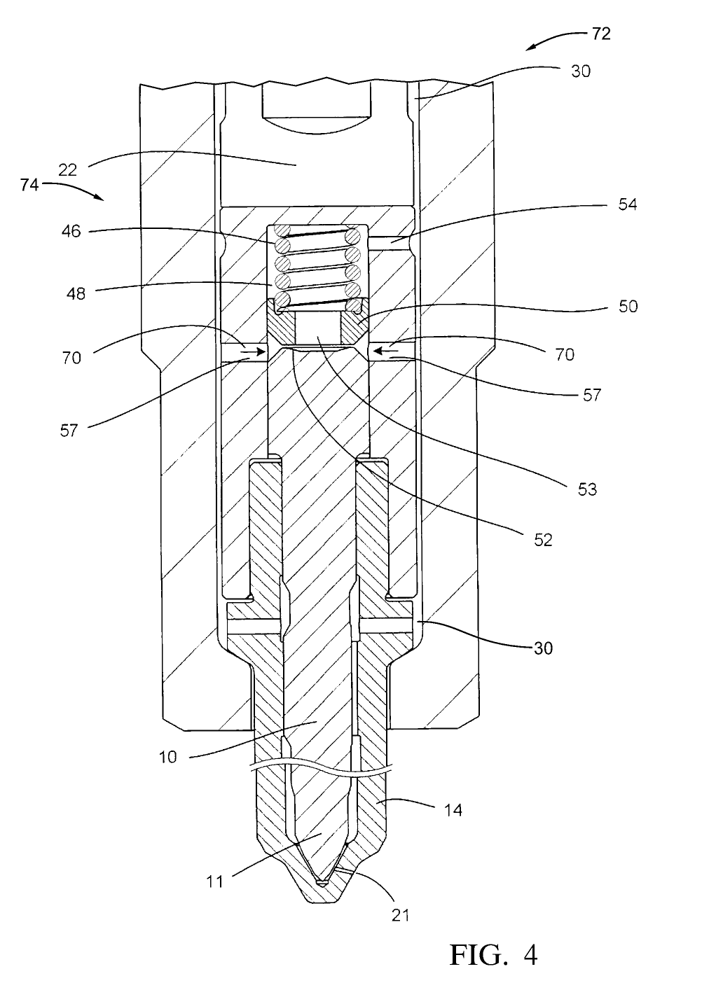

Whilst damping of opening movement of the valve needle 10 has been found to be advantageous, it is preferable for closing movement of the valve needle 10 to be achieved very rapidly. As the voltage across the stack 22 is decreased to the initial voltage level, the piezoelectric stack 22 starts to contract which increases the volume of the damper chamber 48. As the damper chamber volume starts to increase, fuel pressure within the damper chamber 48 starts to decrease and a point is reached at which the annular damper valve 50 is caused to lift away from its damper valve seating 52, as shown in FIG. 4.

The movement of the damper valve 50 away from its seating 52 opens an additional flow path for fuel in which fuel from the accumulator volume 30 is able to flow through the vent passages 57, past the damper valve seating 52, through the central drilling 53 and into the damper chamber 48 at a relatively high rate. This flow of fuel is in addition to fuel flowing back into the damper chamber 48 through the restricted damping orifice 54. The provision of the additional flow path for fuel to enter the damper chamber 48 allows fuel pressure within the damper chamber 48 to increase relatively quickly, assisting closing movement of the valve needle 10 and preventing any significant damping of said movement.

The flow of fuel into the damper chamber 48 via the vent passages 57 is shown in FIG. 4 by the arrows 70.

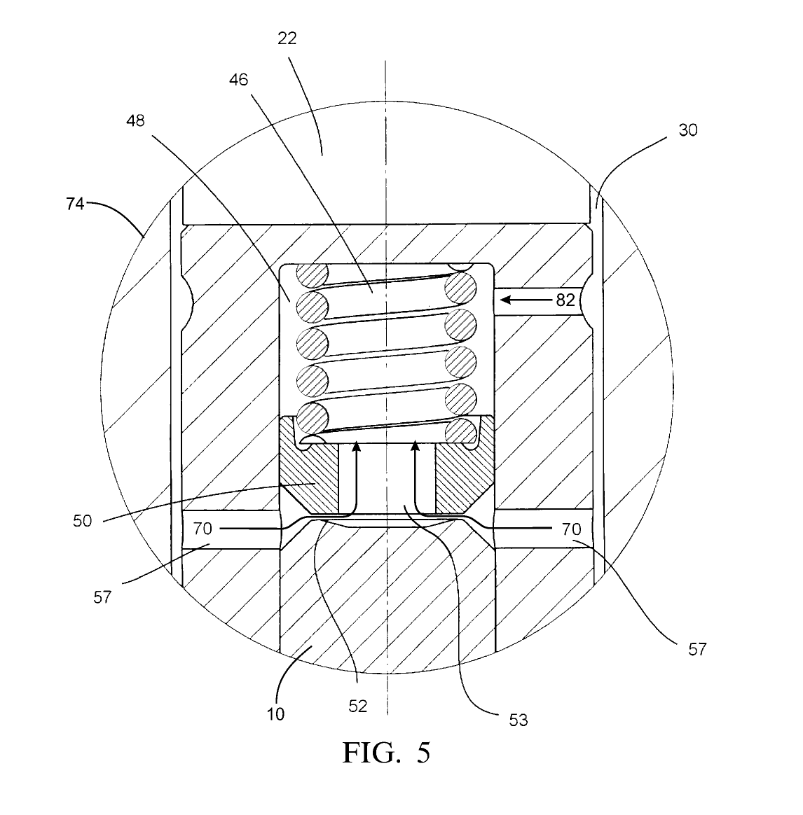

FIG. 5 is an expanded view of the damper valve 50 arrangement shown in FIG. 4 and is provided to show the movement of the valve member 50 more clearly.

It is noted that the damper arrangement described above in relation to FIGS. 1 to 5 provides a one way damper valve on top of the valve needle which provides for a high level of damping during needle lifting but which allows needle closure to take place substantially undamped. The damper arrangement further provides for a flow of fresh fuel through the damper chamber which ensures that the fluid used for damping does not heat to such an extent that changing viscosity and bulk modulus characteristics affect the performance of the fuel injector 72.

Referring again to FIGS. 1-5, the configuration and operating of an embodiment of a fuel injector 72 and associated damping means 74 will be further described. The accumulator volume 30 is generally located within the fuel injector 72. The accumulator volume 30 is generally configured to define a fuel passageway for fuel to flow from the inlet 26 to the injector outlet 21. When the valve needle 10 moves in an opening direction indicated by arrow 66 in FIG. 3, fuel is dispensed through the injector outlet 21, and so fuel flows through the accumulator volume 30 in the direction indicated by arrow 76. The flow of fuel through the accumulator volume 30 assures that fuel in the accumulator volume 30 is refreshed with fresh fuel as fuel is dispensed by the injector 72.

The damping means 74 includes a damper chamber 48 containing fuel to be used for damping. A first fluid path is generally illustrated by arrows 70 (FIG. 5), hereafter the first fluid path 70. The first fluid path 70 provides fluid communication between a first location 78 (FIG. 3) in the accumulator volume 30 and a first end of the damper chamber 48, illustrated herein as the bottom end of the damper chamber 48. The first fluid path 70 includes a vent passage 57 characterized as having a first restriction. The damping means 74 also includes a second fluid path generally illustrated by arrow 64 (FIG. 3) and arrow 82 (FIG. 5), hereafter second fluid path 64 or second fluid path 82 depending on the context. The second fluid path 64, 82 provides fluid communication between a second location 80 in the accumulator volume 30 and a second end of the damper chamber 48, illustrated herein as the top end of the damper chamber 48. As illustrated, the second end of the damper chamber is substantially opposite the first end of the damper chamber 48. Such an arrangement is advantageous so that fresh fuel can flow through the damper chamber, as will be explained in more detail below, and so maintain the damping characteristics of the damping means 74. The second location 80 is spaced apart and distinct from the first location 78 in the accumulator volume 30 so that at least a majority portion of fluid exiting the damping chamber 48 via the second fluid path 64 is not drawn back into the damper chamber 48 via the first fluid path 70. The second fluid path includes a damping orifice 54 characterized as having a second restriction greater than the first restriction of the vent passage 57. The damping orifice 54 is sized to be effective as an orifice for damping.

It should be appreciated that the accumulator volume 30 is configured such that fuel flows past the first location 78 and the second location 80 in the direction of arrow 76 as fuel is dispensed through the injector outlet 21. As such, the fuel present at the first location 78 and the second location 80 is refreshed when the injector 72 is operated to dispense fuel. The damping means 74 also includes a damper valve 50 arranged series wise in the first fluid path 70. The damper valve 50 may be characterized as having variable restriction. As illustrated in FIG. 3, the damper valve may be in a seated position making contact with the top of the valve needle 10, and so fuel is prevented from flowing along the first fluid path 70. As illustrated in FIG. 5, the damper valve may be in an unseated position, not making contact with the top of the valve needle 10, and so fuel may flow along the first fluid path 70. The damper valve 50 is generally configured so that when the damper valve 50 is forced by the valve needle 10 in a direction indicated by arrow 66 (FIG. 3) fuel only flows out of the damper chamber 48 via the second fluid path 64. The size of the damping orifice 54 is selected so that when the needle moves in the opening direction, the damping means 74 damps the opening movement of the valve needle 10. Conversely, when the valve needle 10 moves in a closing direction, that is in a direction opposite that indicated by arrow 66, a gap may form between the damper valve 50 and the valve needle 10, and so fuel flows through the damper valve 50 such that fuel flows through the first fluid path 70. As the damper valve 50 moves downward, thereby increasing the effective volume of the damper chamber 48, fuel also flows into the damper chamber 48 along the second fluid path 82. However, the size and number of vent passages 57, and the gap between the damper valve 50 and valve needle 10 are selected so that the restriction of the first fluid path 70 is less than the restriction of the second fluid path 82. As such, as the damper valve 50 moves up and down, thereby alternately increasing and decreasing the volume of the damping chamber, more fuel flows out of the damping chamber 48 via the second fluid path 64 than flows into the damping chamber 48 via the second fluid path 82. This unbalanced flow through the damping orifice 54 and through the damper valve 50 provides for a flow of fresh fuel through the damper chamber 48 from the first end of the damper chamber to the second end of the damper chamber.

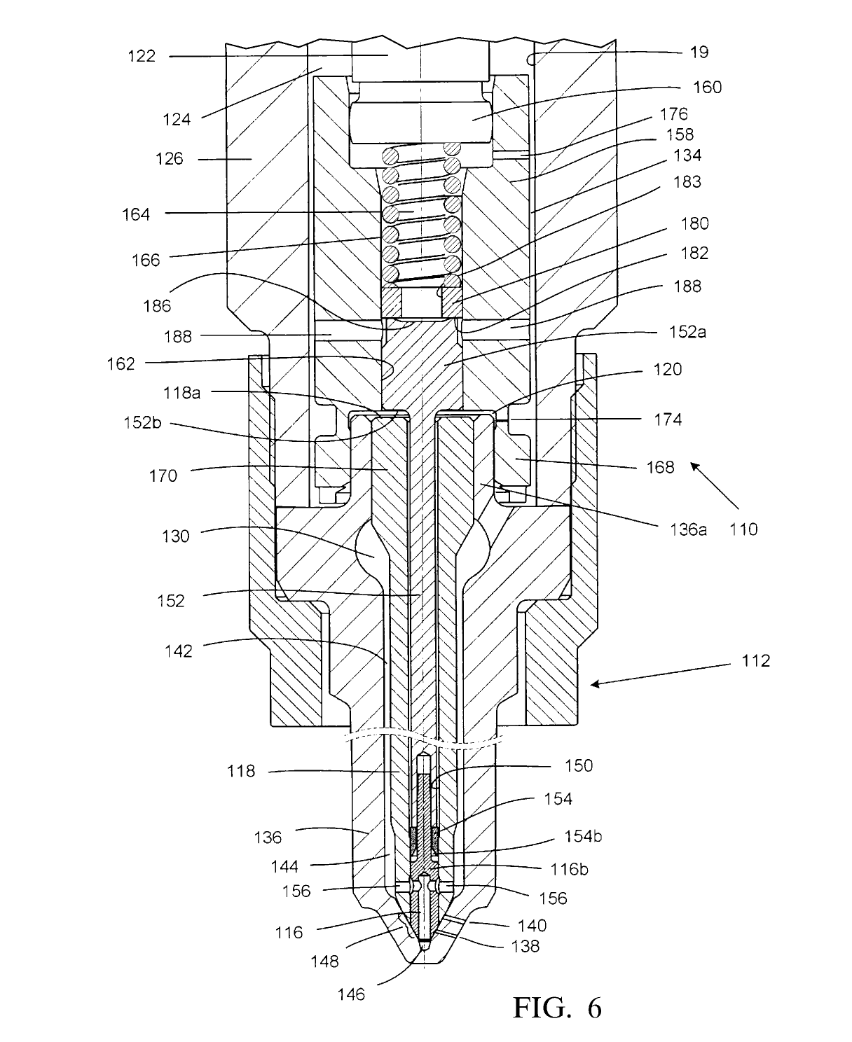

FIG. 6 shows an embodiment according to the present invention in relation to an injector that comprises an inner valve needle arranged concentrically within an outer valve, each of the needles controlling the delivery of fuel into the combustion chamber of an internal combustion engine.

Referring to FIG. 6, an injector, referred to generally as 110, includes an injection nozzle, referred to generally as 112, and an actuation means including a piezoelectric actuator (not shown in the Figure) for controlling movement of first and second injection nozzle valves, 116 and 118 respectively, by controlling fuel pressure within an injector control chamber 120. The piezoelectric actuator may be of known type, comprising a stack 122 of piezoelectric elements which are caused to extend and contract upon application of a voltage across the stack 122. It is a feature of the piezoelectric stack 122 that it is housed within a fuel-filled chamber 124 defined within an injector housing part, or injector body 126. The chamber 124 housing the stack 122 defines a part of the fuel supply path between an injector inlet (not shown in FIG. 6) and a supply chamber 130 of the nozzle, the path also being defined by a drilling (not shown in FIG. 6) provided in the upper region of the injector body 126 and a lower region 134 of the chamber 124, as will be described further below. In use, fuel is supplied to the injector inlet from a high pressure fuel source in the form of a common rail or accumulator volume (not shown), and flows through the stack chamber 124 into the nozzle supply chamber 130. Further details of a piezoelectric actuator can be found in the Applicant's European Patent EP 0995901 (Delphi Technologies Inc.).

The injection nozzle 112 includes a nozzle body 136 provided with first and second outlets, 138 and 140 respectively, which are spaced axially along the main nozzle body axis so that the second outlet 140 adopts a higher axial position along the nozzle body 136 than the first outlet 138. The first outlet 138 is of relatively small diameter to present a relatively small flow area for fuel being injected into the engine, and the second outlet 140 is of relatively large diameter so as to present a larger flow area for fuel being injected into the engine. Only a single first outlet 138 and a single second outlet 140 are shown, but in practice a set of more than one first outlet and a set of more than one second outlet may be provided. For the purpose of the following description, therefore, reference will be made to a set of first outlets 138 and a set of second outlets 140.

The nozzle body 136 is provided with an axially extending blind bore 142 which defines a first, upper delivery chamber 144 for receiving fuel under high pressure from the nozzle supply chamber 130. The axial bore 142 also defines, at its blind end, a second, lower delivery chamber 146 for fuel. Toward its blind end, the internal surface of the bore 142 is of frustro-conical form and here defines a valve seating surface, indicated generally as 148, for both the inner and outer valves 116, 118.

The first and second coaxial valves 116, 118 are arranged concentrically within the bore 142 to allow control of the flow of fuel between the upper delivery chamber 144 and the first and second sets of outlets, 138, 140 respectively. The first valve member takes the form of a first inner valve, or valve needle 116, movement of which controls whether or not fuel is delivered through the first outlets 138. The second valve member takes the form of an outer valve 118, movement of which controls whether or not fuel is delivered through the second outlets 140. The outer valve is in the form of a sleeve having an axially extending through bore 150. The outer valve 118 includes an enlarged region 118a at its upper end for co-operation with the adjacent region of the nozzle body bore 142 to guide sliding movement of the outer valve 118, in use. The inner valve needle 116 and the outer valve 118 are engageable with respective seatings, defined by the valve seating, as described further below. In FIG. 6, the inner and outer valves 116, 118 are in seated positions, and the injector is said to be in a non-injecting state.

At its upper end, the inner valve needle 116 is coupled to a carrier member 152, or inner valve carrier member, which extends along the valve bore 150, with the inner valve needle 116 being received within a lower portion of the bore 150. The inner valve needle 116 includes an upper stem 116a having a relatively small diameter, which is received within a lower region of the carrier member 52 to couple the parts together in a secure fashion (e.g. by means of a screw thread connection or an interference fit). The inner valve needle 116 is shaped to include a collar, either integrally formed therewith or carried as a separate part, which co-operates with the bore 150 in the outer valve 118 so as to guide sliding movement of the inner valve needle 116. The carrier member 152 terminates, at its upper end, in an enlarged head 152a.

The outer valve 118 is further provided with radially extending drillings 156, outer ends of which communicate with the upper delivery chamber 144 and inner ends of which communicate with flats or grooves provided on the outer surface of the inner valve needle 116. The radially extending drillings 156 and the flats together define a flow passage means for allowing fuel to flow between the upper delivery chamber 144 and the lower delivery chamber 146.

The actuation means of the injector further includes a transmitting means for transmitting an actuation force, due to extension or contraction of the piezoelectric stack 122, to the inner and outer valves 116, 118 to permit their independent movement. The transmitting means includes a sleeve member 158, which is carried by an end piece 160 of the piezoelectric stack 122, and the injection control chamber 120 for receiving fuel at injection pressure. The actuator piston 158 takes the form of a sleeve defining a piston bore 162 that defines, at its upper end, a first damper chamber 164 for housing a first, inner valve spring 166. The enlarged head 152a of the carrier member 152 is received within the lower portion of the piston bore 162 so that the inner valve spring 166 serves to urge the inner valve needle 16 into engagement with its seating 148.

A skirt 168 extends downwardly from the base of the sleeve 158 to define an enlarged recess for receiving, in a sliding fit, an upper extension 136a of the nozzle body 136. The arrangement is such that the lower surface 152b of the enlarged head 152a of the carrier member 152 faces the upper end surface 118a of the outer valve 118. The control chamber 120 of the load transmitting means is therefore defined within the recess by a surface of the sleeve 158, the upper surface 118a of the outer valve 118, the lower surface 152b of the enlarged head 152a of the carrier member 152 and the upper surface 136b of the nozzle body extension 136a.

The control chamber 120 communicates with the stack volume 124, 134 through a restrictive flow means in the form of a restricted passage or orifice 174 provided in the skirt 168 of the sleeve 158. One end of the restricted passage 174 communicates with the control chamber 120 and the other end of the restricted passage 174 communicates with the stack volume 124, 134. The restricted passage 174 ensures fuel pressure within the control chamber 120 tends to equalise with injection pressure at the end of injection, which has advantages for injector operation as will be described further below.

The sleeve 158 is further provided with a radially extending drilling 176 to provide a communication path between the damper chamber 164 and the stack chamber 124. If the drilling 176 is of restricted diameter, it provides a means for damping movement of the carrier member 152, and hence of the inner valve needle 116, as discussed further below.

One end of the inner valve needle spring 166 abuts the lower surface of the end piece 160 of the piezoelectric stack 122 and the other end of the spring 166 abuts a damper valve arrangement 180, 182. The damper valve arrangement includes an annular damper valve 180 located within the damper chamber 164 and engageable with a valve seating 182 defined by an upper surface of the carrier member 152. The annular damper valve 180 defines a means for aiding rapid closure of the valve needle 116 at the end of injection. The damper valve 180 is provided with a central drilling 183, one end of which communicates with the damper chamber 164 and the other end which communicates with a recessed portion 186 of the upper end of the carrier member 152.

The damper chamber 164 is provided with a radially extending drilling 176 to provide a fluid communication path between the damper chamber 164 and the stack chamber (accumulator volume) 124. The drilling (or damper orifice) 176 is of restricted diameter such that it provides a means for damping the opening of the valve needle 116 as described below.

The sleeve 158 is provided with further radially extending drillings 188 (vent passages). In use, the damper valve 180 is subject to fuel pressure variations within the damper chamber 164. In the event that the pressure within the chamber 164 varies sufficiently, the damper valve 180 may move from its seating 182 against the action of the spring 166 such that an additional flow path is opened between the damper chamber 164 and the accumulator volume 124 via the vent passages 188. The movement of the damper valve 180 and the flow path through the vent passages 188 is described in more detail below.

When the energisation level of the stack 122 is such that the inner valve needle 116 only lifts then the functionality of the damper chamber will essentially be the same as described for the single valve needle embodiment in FIGS. 1-5. The lifting of the needle 116 will cause a reduction in volume of the damper chamber 164. Fuel will flow through the damper orifice 176 into the accumulator volume 124. As the damper orifice 176 is of restricted diameter the flow of fuel through the orifice will be restricted and the lifting of the needle 116 will therefore be damped.

As the voltage across the stack 122 is decreased to an initial voltage level, the piezoelectric stack 122 starts to contract which increases the volume of the damper chamber 164. As the damper chamber volume starts to increase, fuel pressure within the damper chamber 164 starts to decrease and a point is reached at which the annular damper valve 180 is caused to lift away from its damper valve seating 182.

The movement of the damper valve 180 away from its seating 182 opens an additional flow path for fuel in which fuel from the accumulator volume 124 is able to flow through the vent passages 188, past the damper valve seating 182, through the central drilling 183 and into the damper chamber 164 at a relatively high rate. This flow of fuel is in addition to fuel flowing back into the damper chamber 164 through the restricted damping orifice 176. The provision of the additional flow path for fuel to enter the damper chamber 164 allows fuel pressure within the damper chamber 164 to increase relatively quickly, assisting closing movement of the valve needle 116 and preventing any significant damping of said movement.

It is noted that the embodiment described in relation to FIG. 6 provides an injector with the ability to inject at two different injection rates, i.e. first outlets 138 only open, and both first and second outlets (138, 140) open. This provides the particular advantage that different fuel injection rates can be achieved for engine operation at different engine loads. It is noted that by varying the energisation level of the piezoelectric stack 122 by varying the voltage across the stack to a number of different voltages, the various outlet positions may be achieved. Further details of a two valve needle injector can be found in the Applicant's European Patent EP 05250254.9 (Delphi Technologies Inc.).

The damper arrangement described in relation to the injector shown in FIG. 6 also provides a one way damper valve which provides for a high level of damping during inner valve needle lifting but which allows needle closure to take place substantially undamped. A flow of fresh fuel is also provided for through the damper chamber which ensures that the damper fluid temperature does not rise excessively.

It is noted however that when the outer valve needle only is moved there will be some damping of the stack caused by movement of the sleeve alone changing the damper volume.

It will be understood that the embodiments described above are given by way of example only and are not intended to limit the invention, the scope of which is defined in the appended claims. It will also be understood that the embodiments described may be used individually or in combination.

1. A fuel injector for use in an internal combustion engine, the fuel injector comprising:
an inlet for receiving fuel, an accumulator volume, a valve needle, a valve needle seat, a control chamber, an injector outlet, an actuator arrangement, and damping means for damping opening movement of the valve needle;
the accumulator volume located within the fuel injector, said accumulator volume configured to define a fuel passageway for fuel to flow from the inlet to the injector outlet;
the valve needle being engageable with the valve needle seat to control fuel injection through the injector outlet;
the actuator arrangement being arranged to control fuel pressure within the control chamber, a surface associated with the valve needle being exposed to fuel pressure within the control chamber such that fuel pressure variations within the control chamber control movement of the valve needle relative to the valve needle seat;
the damping means comprising a damper chamber containing fuel, a damper valve defining a portion of a first fluid path having variable restriction between a first location in the accumulator volume to a first end of the damper chamber, a vent passage defining another portion of the first fluid path between a first location in the accumulator volume to the first end of the damper chamber, and a damping orifice defining a second fluid path having fixed restriction directly from a second end of the damper chamber to a second location in the accumulator volume spaced apart from the first location, wherein the accumulator volume is configured such that fuel flows past the first location and the second location as fuel flows through the injector outlet, whereby fuel at the first location and the second location is refreshed, wherein the second fluid path is distinct and separate from the first fluid path, the damping orifice having a restricted diameter effective for damping, the damper valve being arranged such that fuel flowing out of the damper chamber flows only through the damping orifice during opening movement and so is restricted so as to damp opening movement of the valve needle;
wherein the vent passage is arranged to provide an additional fuel flow path through the damper valve into the damper chamber during closing movement of the valve needle, wherein the first fluid path and the second fluid path connect to the damper chamber at locations that are substantially displaced, thereby providing for a flow of fresh fuel through the damper chamber from the first end of the damper chamber to the second end of the damper chamber.

2. An injector as claimed in claim 1, wherein the injector is arranged such that an increase in fuel pressure within the control chamber causes the valve needle to lift away from the valve needle seating.

3. An injector as claimed in claim 1, wherein the damper valve comprises a spring which serves to bias the valve needle towards the valve needle seat.

4. An injector as claimed in claim 1, wherein the actuator arrangement is coupled to a sleeve member defining a sleeve bore, the control chamber further comprising the sleeve bore.

5. A fuel injector as claimed in claim 1, wherein variable restriction in the first fluid path is provided by a valve member operable between a seated position in which it blocks the first fluid path and an unseated position in which allows fuel to flow in the first fluid path.

6. A fuel injector as claimed in claim 5, wherein the valve member is in its seated position during opening movement of the valve needle and in its unseated position during closing movement of the valve needle, the valve member moving between its seated and unseated positions in response to fuel pressure variations within the damper chamber.

7. A fuel injector as claimed in claim 5, wherein the valve member comprises an annular valve member which is in close contact with the bore of the sleeve member.

8. A fuel injector as claimed in claim 5, wherein the valve member is biased towards its seated position.

9. A fuel injector as claimed in claim 1, further comprising restricted flow means for equalising pressure between the control chamber and the fuel source at the end of injection.

10. A fuel injector as claimed in claim 1, further comprising restricted flow means for equalising pressure between the control chamber and the fuel source at the end of injection wherein:
(i) the actuator arrangement is coupled to a sleeve member defining a sleeve bore, the control chamber further comprising the sleeve bore; and
(ii) the restricted flow means includes a restricted flow passage provided in the sleeve member, the restricted flow passage being arranged to fluidly connect the control chamber to the source of pressurised fuel.

11. A fuel injector as claimed in claim 1, wherein closing movement of the valve needle is substantially undamped.

12. A fuel injector for use in an internal combustion engine, the fuel injector comprising:
an inlet coupled to a fuel source;
a valve needle movable in an opening direction and a closing direction relative to a valve needle seat to control fuel dispensed through an injector outlet;
an accumulator volume located within the fuel injector, said accumulator volume configured to define a fuel passageway for fuel to flow from the inlet to the injector outlet; and
a damping means comprising a damper chamber containing fuel, a first fluid path between a first location in the accumulator volume and a first end of the damper chamber, said first fluid path comprising a vent passage characterized as having a first restriction, said damping means further comprising a second fluid path between a second location in the accumulator volume and a second end of the damper chamber, said second end of the damper chamber substantially opposite the first end of the damper chamber, said second location spaced apart and distinct from the first location in the accumulator volume, said second fluid path comprising a damping orifice characterized as having a second restriction greater than the first restriction and effective for damping, wherein the accumulator volume is configured such that fuel flows past the first location and the second location as fuel is dispensed through the injector outlet, whereby fuel at the first location and the second location is refreshed, said damping means further comprising a damper valve arranged series wise in the first fluid path, said damper valve characterized as having variable restriction, said damper valve configured such that fuel flowing out of the damper chamber flows only through the second fluid path when the needle moves in the opening direction so as to damp opening movement of the valve needle, and fuel flows through the damper valve when the needle moves in the closing direction such that fuel flows through the first fluid path and the second fluid path when the needle moves in the closing direction, thereby providing for a flow of fresh fuel through the damper chamber from the first end of the damper chamber to the second end of the damper chamber.

13. A fuel injector as claimed in claim 12, wherein the damper valve is operable between a seated position in which it blocks the first fluid path and an unseated position in which allows fuel to flow in the first fluid path.

14. A fuel injector as claimed in claim 13, wherein the damper valve is biased towards the seated position.

15. A fuel injector as claimed in claim 12, wherein closing movement of the valve needle is substantially undamped.
